(19) United States
(12) Patent Application Publication
(10) Pub. No.: US 2023/0108460 A1
(43) Pub. Date: Apr. 6, 2023

(54) ENERGY STORAGE ELEMENT ENCLOSURE

(71) Applicant: International Truck Intellectual Property Company, LLC, Lisle, IL (US)

(72) Inventors: CHAD AUFDENBERG, Oswego, IL (US); JAY E. BISSONTZ, Spencerville, IN (US); GREGORY W. CAMERON, Davison, MI (US); RAYMOND W. BAGGETT, Naperville, IL (US); ANTHONY D. SUTTON, Saint Charles, IL (US); RONALD G. DREXLER, Westmont, IL (US); TOMASZ J. MROWCA, Carol Stream, IL (US); ROBERT J. BERNAS, JR., Wheaton, IL (US); CHRISTOPHER A. BOOKOUT, Oswego, IL (US)

(73) Assignee: International Truck Intellectual Property Company, LLC, Lisle, IL (US)

(21) Appl. No.: 17/492,884

(22) Filed: Oct. 4, 2021

(51) Int. Cl. H01M 50/249; B62D 33/06; H01M 50/204; H01M 50/271

(52) U.S. Cl. CPC H01M 50/249; B62D 33/06; H01M 50/204; H01M 50/271; H01M 2220/20

(57) ABSTRACT

An enclosure for at least one energy storage element on a vehicle having a cab comprises a first panel supporting the at least one energy storage element connected to the cab of the vehicle, and a second panel supporting another at least one energy storage element connected to the cab opposite to the first panel.

### BACKGROUND

This disclosure relates generally to an enclosure for an energy storage element. More specifically, this disclosure relates to an energy storage element enclosure disposed on a vehicle.

Currently, a vehicle may use more than one energy storage elements mounted on the vehicle. Sometimes, the vehicle may have battery box enclosing batteries. The battery box is mounted to an appropriate portion, such as a frame and the like, of the vehicle. Given dimensions, such as size, weight and the like, of the battery box and the enclosed batteries, the appropriate portion of the vehicle may need to be enhanced and strengthened, sometimes by adding material, weight, complexity, and cost to the vehicle. Doing this may locate the batteries outside of an area of thermal stability of the vehicle. Lack of thermal stability can decrease battery performance, durability and longevity among other things. Also, frequency of servicing of a battery makes ease of battery access desirable.

### SUMMARY

This disclosure provides embodiments of an enclosure of an energy storage element. According to one embodiment, an enclosure for at least one energy storage element on a vehicle having a cab comprises a first panel supporting the at least one energy storage element connected to the cab, and a second panel supporting another at least one energy storage element connected to the cab opposite to the first panel.

### DESCRIPTION OF THE DRAWINGS

FIG. 1 is an elevational view of a portion of a vehicle including a portion of an embodiment of an energy storage element enclosure disclosed herein;

FIG. 2 is a perspective view of another portion of the energy storage element enclosure of FIG. 1;

FIG. 3 is an elevational view of an additional portion, opposite to the portion of FIG. 1, of a vehicle including an embodiment of an energy storage element enclosure disclosed herein;

FIG. 4 is a perspective view of a cover for the another portion of the energy storage element enclosure of FIG. 2 with a mount;

FIG. 5 is a perspective view of the another portion of the energy storage element enclosure of FIG. 4 showing interior of the another portion of the energy storage element enclosure of FIG. 4 with the mount; and

FIG. 6 is a perspective view

### DETAILED DESCRIPTION

This disclosure relates to an embodiment of an enclosure 10 for an element of a vehicle. Embodiments illustrated in the Figures comprise an enclosure 10 for at least one energy storage element 2 on a vehicle.

Any desired number of at least one energy storage element 2 can be used with the enclosure 10. The at least one energy storage element 2 may comprise any suitable element, such as a battery, a lead/acid battery, a lithium ion battery, a solid-state battery, a capacitor, and inductor and the like, that provides energy to the vehicle. The at least one energy storage element 2 may provide any desired voltage, such as twelve (12) volts, twenty-four (24) volts, or any desired voltage. The vehicle may be anything, such as a passenger car, a truck, a tractor, an aircraft, an all-terrain vehicle, a recreational vehicle, a boat, other marine applications and the like, that uses energy. The at least one energy storage element 2 is suitably connected with other energy needing parts of the vehicle. For instance, when the energy is electrical energy, a suitable connection may be provided by a conductor, possibly in wire form, and the like, possibly disposed in a conduit or the like. In some embodiments, the at least one energy storage element 2 has a modular configuration thereby allowing the at least one energy storage element 2 to be removed, to be replaced, to be charged, to be serviced at the like.

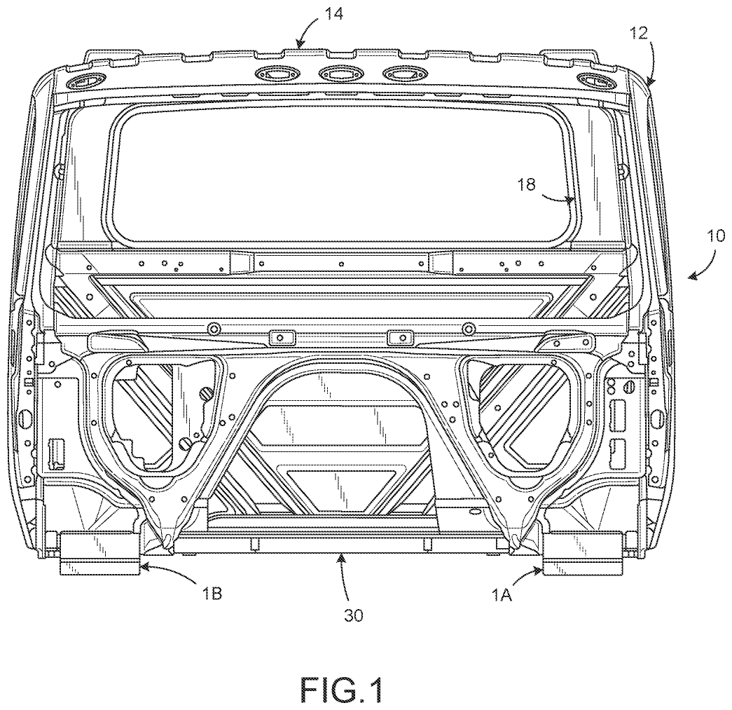

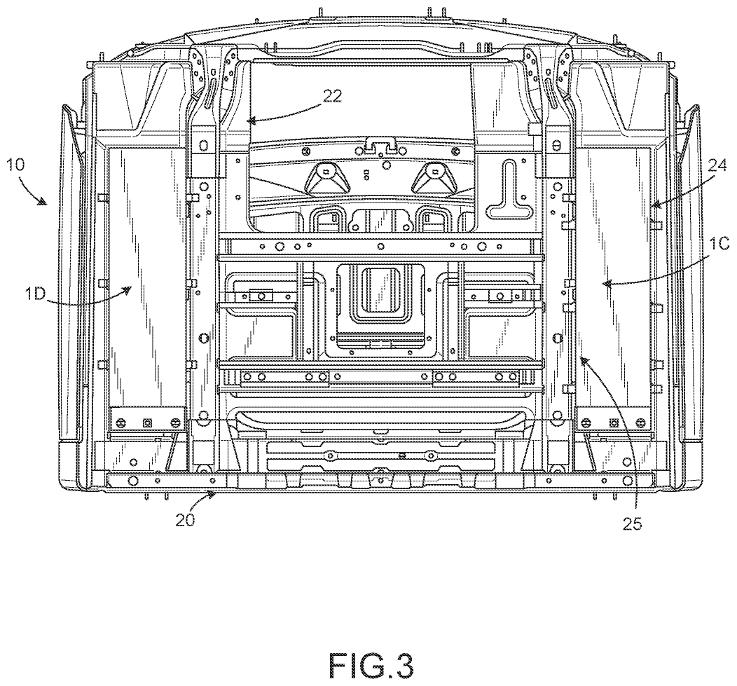

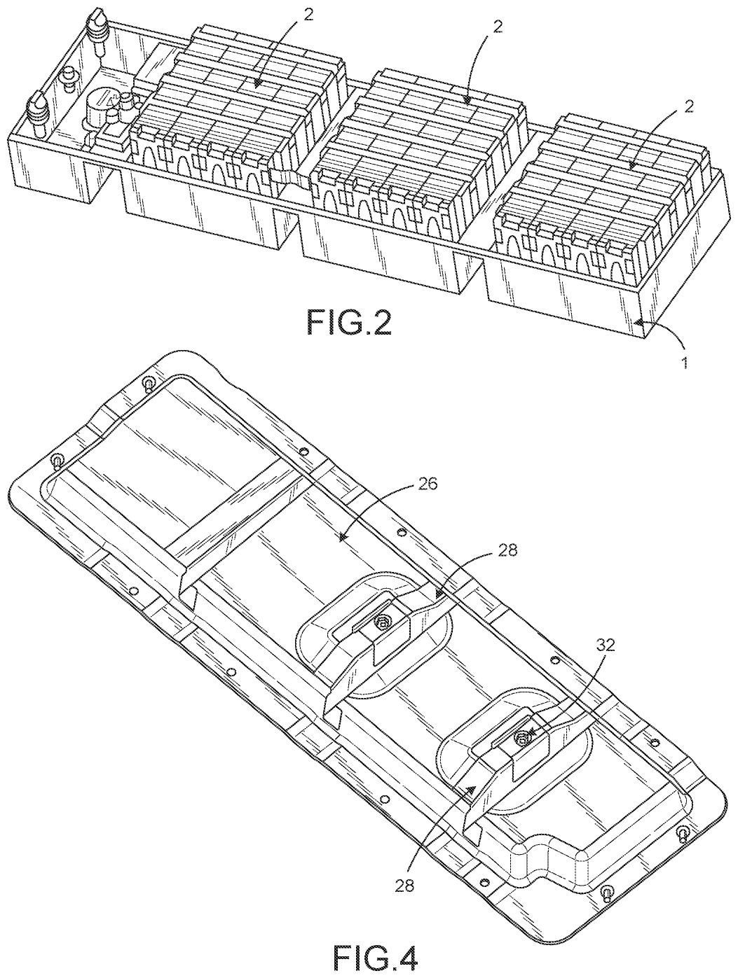

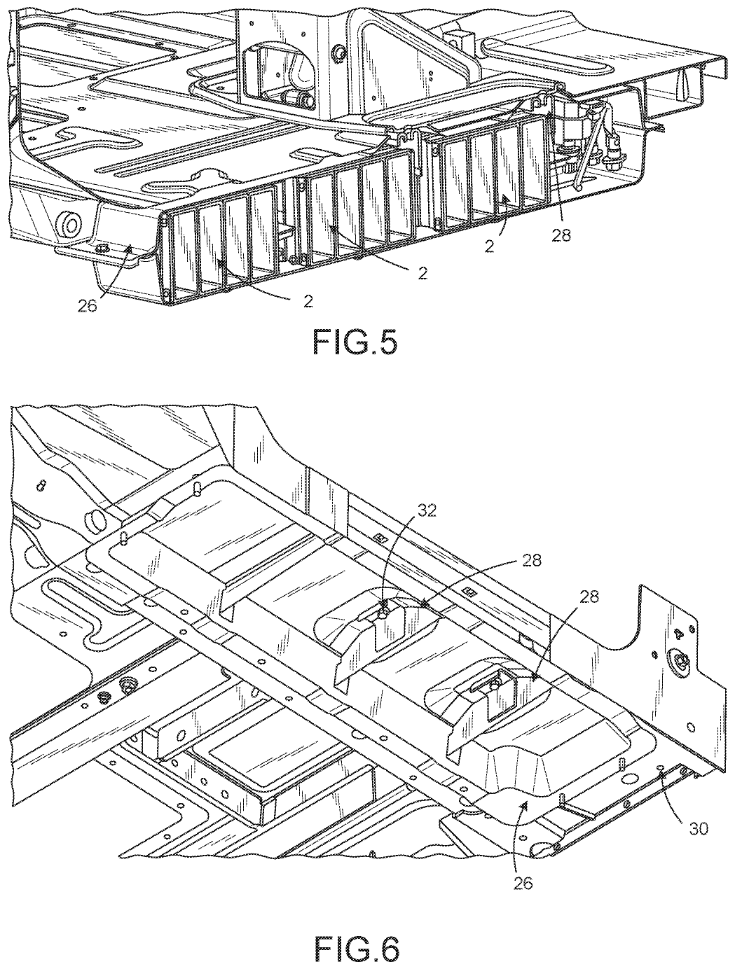

The embodiment of FIG. 1 comprises a first panel 1 that supports at least one energy storage element 2, three (3) at least one energy storage element 2 being shown in FIG. 2, disposed on the vehicle. Any desired number or multiple of at least one energy storage element 2 may be included, possibly with sufficient modification, on the first panel 1. The first panel 1 is connected with appropriate structure of the vehicle. In some embodiments, the first panel 1 is movably connected with appropriate structure of the vehicle. In some embodiments, the first panel 1 has a modular configuration thereby allowing the first panel 1 to be removed, to be replaced, to be serviced and the like. In some embodiments, the first panel 1 may comprise a first piece joined to a second piece by a mechanical bearing, such as a hinge and the like. Relative movement of the first piece and the second piece can allow access to the at least one energy storage element 2. With this embodiment, at least one of the first piece and the second piece may connect with a portion, such as an underside and the like, of a cab 12 comprising the vehicle. Embodiments of the enclosure 10 may comprise any appropriate number of first panel 1 to provide a desired amount of energy.

In the embodiment illustrated in FIGS. 1 and 3, there are four (4) at least one panel 1 connected with the cab 12 comprising the vehicle. Specifically, as shown in FIG. 1, a first at least one panel 1A is disposed adjacent an end 14, i.e. a front end, of the cab 12 opposite to an end 20, i.e. a rear end, of the cab 12. The end 14 of the cab 12 may include an aperture 18 for a windshield. The first at least one panel 1A is located adjacent a floor pan 30 of the cab 12. A second at least one panel 1B is disposed adjacent the end 14 of the cab 12 opposite to the first at least one panel 1A.

FIG. 3 shows a third at least one panel 1C and a fourth at least one panel 1D disposed adjacent the end 20 of the cab 12 opposite to the end 14 of the cab 12 that includes the first at least one panel 1A and the second at least one panel 1B. The third at least one panel 1C is disposed on the end 20 of the cab 12 on a side thereof opposite to the fourth at least one panel 1D. In one embodiment an aperture 22 is located between the third at least one panel 1C and the fourth at least one panel 1D. The aperture 22 may contain a window and the like.

In some embodiments, at least one of the at least one first panel 1A, the at least one second panel 1B, the at least one third panel 1C and the at least one fourth panel 1D is coupled to at least one of the end 14 of the cab 12 and the end 20 of the cab 12 by at least one first joint 24, such as a mechanical bearing, a hinge and the like. In some embodiments, the at least one first joint 24 may allow for movement of the at least one of the at least one first panel 1A, the at least one second panel 1B, the at least one third panel 1C and the at least one fourth panel 1D. In some embodiments, at least one second joint 25, indicated in FIG. 3, may be used with the at least one first joint 24 to couple the at least one of the at least one first panel 1A, the at least one second panel 1B, the at least one third panel 1C and the at least one fourth panel 1D to the cab 12 of the vehicle. In some embodiments, the at least one first joint 24 may function substantially similarly to a hinge and the at least one second joint 25, used with the at least first joint 24 functioning substantially similarly to a hinge, may function substantially similarly to combination of mechanical attachment and integration interface of the at least one of the at least one first panel 1A and the at least one second panel 1B, and the at least one third panel 1C and the at least one fourth panel 1D. In some embodiments, the at least one second joint 25 may be substantially similar to a bolt, a stud, a pin, a cam, a tab, a rail, any combination of the foregoing and the like.

In some embodiments, such as that shown in FIG. 4, a cover 26 may be disposed over at least one of the at least one first panel 1A, the at least one second panel 1B, the at least one third panel 1C and the at least one fourth panel 1D. In some embodiments where the cover 26 is disposed adjacent the floor pan 30 of the cab 12, the cover 26 may accommodate at least one mount 28. In some embodiments, the at least one mount 28 may include a bore 32. The bore 32 may accommodate a suitable fastener, such as a fastener useful in securing a fixture, such as a seat and the like, to the cab 12. It is possible that use of an embodiment of the enclosure 10 on a vehicle in this manner may increase integrity and/or strength of attaching the fixture, such as a seat and the like, to the cab 12.

Using an embodiment of the enclosure 10 may permit location of at least one energy storage element 2 proximate to a section of a vehicle that provides thermal energy beneficial to the at least one energy storage element 2 thereby increasing thermal stability of the at least one storage element 2. An embodiment of the enclosure 10 can provide a barrier between the at least one energy storage element 2 and an interior, possibly containing an occupant, of the vehicle. An embodiment of the enclosure 10 can provide consistent mounting and packaging of at least one energy storage element 2 in a vehicle. An embodiment of the enclosure 10 may comprise a structural element of the cab 12 of the vehicle, thereby allowing the cab 12 to include less material that a cab that does not include an embodiment of the enclosure. In this manner, an embodiment of the enclosure 10 may provide structural benefits substantially similar to structural benefits provided by a windshield on a cab.

What is claimed is:

1. An enclosure for a first at least one energy storage element on a vehicle having a cab, the enclosure comprising:
a first panel supporting the first at least one energy storage element connected to the cab of the vehicle; and
a second panel supporting a second at least one energy storage element connected to the cab of the vehicle opposite to the first at least one panel.

2. The enclosure as defined in claim 1 wherein the first at least one energy storage element comprises multiple energy storage element.

3. The enclosure as defined in claim 1 wherein four first panel are connected to the cab of the vehicle.

4. The enclosure as defined in claim 1 further comprising:
a third panel supporting a third at least one energy storage element disposed adjacent an end of the cab opposite to the first panel and the second panel.

5. The enclosure as defined in claim 4 further comprising:
a fourth panel supporting a fourth at least one energy storage element disposed adjacent an end of the cab opposite to the first panel and the second panel and opposite to the third panel.

6. The enclosure as defined in claim 1 further comprising:
at least one joint coupling at least one of the at least one first panel and the at least one second panel to the cab of the vehicle.

7. The enclosure as defined in claim 6 further comprising:
at least one second joint coupling at least one of the at least one first panel and the at least one second panel to the cab of the vehicle.

8. The enclosure as defined in claim 1 further comprising:
a cover disposed over at least one of the first panel and the second panel.

9. The enclosure as defined in claim 8 wherein the cover accommodates at least one mount.

10. The enclosure as defined in claim 9 wherein the at least one mount includes a bore.
